(19) United States
(12) Patent Application Publication
(10) Pub. No.: US 2018/0292289 A1
(43) Pub. Date: Oct. 11, 2018

(54) SENSING PRESSURE VARIATIONS IN PIPELINES

(71) Applicant: Atmos Wave Limited, Manchester, Lancashire (GB)

(72) Inventor: Andrew Hoffman, Manchester, Lancashire (GB)

(73) Assignee: Atmos Wave Limited, Manchester, Lancashire (GB)

(21) Appl. No.: 15/766,266

(22) PCT Filed: Oct. 6, 2016
(86) PCT No.: PCT/GB2016/053117

§ 371 Date: Apr. 5, 2018

(30) Foreign Application Priority Data
Oct. 6, 2015 (GB) 1517631.6

(51) Int. Cl. G01M 3/28; G01L 9/00; G01M 3/36

(52) U.S. Cl. CPC G01M 3/2815; G01M 3/36; G01L 9/0026

(57) ABSTRACT

A pressure sensing device is operable to monitor pressure variations within a fluid pipeline. The pressure sensing device comprises a pair of complementary sensor elements. At least one of the sensor elements is mounted to a supporting bracket that is mounted to a point on the external surface of the pipeline. At least one sensor element is mounted such that the pair of complementary sensor elements experience relative displacement as the external surface of the pipeline undergoes changes in size or shape. The pair of complementary sensor elements are operable to detect said relative displacement and thereby provide an indication of pressure variation within the pipeline.

### TECHNICAL FIELD OF THE INVENTION

The present invention relates to sensing pressure variation in pipelines and in particular to sensing pressure variations in pipelines by means of an external sensing device.

### BACKGROUND TO THE INVENTION

It is often necessary to convey fluids such as water and oil over large distances and, as such, these fluids often flow under pressure through a dedicated system of pipes. In order to monitor operation of such pipelines it is common to use flow meters at set points along the pipeline. By integrating the output of such monitors over extended time periods, it is possible to detect a flow discrepancy and hence determine the occurrence of a leak. Nevertheless, there is necessarily a time delay between the leak occurring and a positive determination that is has occurred.

Such pipes are susceptible to leaks where the pipes are breached, either accidentally or purposely by a third party. It is important that such leaks or thefts be identified and located as quickly as possible so as to reduce the amount of fluid lost. Furthermore, in the case of an accidental leak of a fluid such as oil, early detection can help minimise the environmental impact of the leak. On the other hand, it is also important to avoid false alarms since the process of shutting down a pipeline for a length of time to investigate a suspected leak is time consuming and expensive.

When a leak develops in a pipeline the line fluid pressure in a section of the pipeline near to the leak will drop. The initial pressure drop is a dynamic effect caused by the inability of the fluid to respond instantly to the leak. After this initial pressure drop, the pressure continues to drop at a slower rate due to unpacking of the pipeline. Such a pressure drop reduces the flow rate of pumped fluid in the pipeline beyond the leak.

One known method of monitoring a pipeline uses flow meters to monitor the rate of flow of fluid at set points on the conduit. However, the output of such monitors must be integrated over a suitable time period in order to detect a flow discrepancy. As such, there is necessarily a time delay between the leak occurring and a positive determination that is has occurred. There is also a limitation that this method can only detect leaks occurring between pairs of flow meters and therefore the accuracy of any positional determination of a leak is limited by the number of flow meters provided along the pipeline. As such flow meters are provided within the pipeline, it is difficult and expensive to fit, reposition or service the flow meters. It is also difficult and expensive to introduce additional flow meters.

Other known methods of monitoring pipelines utilise pressure sensors mounted within the pipeline to measure changes in pressure within the pipeline. By monitoring such changes in pressure, the presence of a leak can be inferred. Some methods, such as that disclosed in WO2011/070343 can also allow the position of a suspected leak to be identified. Once again, these methods typically rely on internal pressure sensors provided within the pipeline. As such, these suffer from the same problems as noted in respect of flow meters above in terms of fitting, repositioning or servicing.

It is an object of embodiments of the present invention to at least partially address the above problems.

### SUMMARY OF THE INVENTION

According to a first aspect of the present invention there is provided a pressure sensing device operable to monitor pressure variations within a fluid pipeline, the pressure sensing device comprising: a pair of complementary sensor elements, at least one of the sensor elements mounted to a supporting bracket that is mounted to a point on the external surface of the pipeline, wherein the at least one sensor element is mounted such that the pair of reference complementary sensor elements experience relative displacement as the external surface of the pipeline undergoes changes in size or shape; and wherein the pair of complementary sensor elements are operable to detect said relative displacement and thereby provide an indication of pressure variation within the pipeline.

By mounting the pair of complementary sensor elements to a point on the circumference of the pipeline, the relative displacement between the sensor elements is related to variations in the external size and shape of the pipeline, which are in turn determined by variation in pressure within the pipeline. Accordingly the present invention provides for convenient measurement of internal pressure within a pipeline using an externally mounted device. As the device is externally mounted, it can be readily fitted, serviced or repositioned without impacting on the flow within the pipeline. In addition, by using a plurality of devices mounted at different points along the pipeline, the relative displacement between the sensor elements and their target elements can be determined along the pipeline and thus variations in pressure along the pipeline can be identified.

Each of the sensor elements may be mounted to a supporting bracket.

At least one of the sensor elements may be provided on a reference platform mounted to a supporting bracket. Each of the senor elements may be provided on a reference platform mounted to a supporting bracket.

Each supporting bracket may be mounted to a separate point on the external surface of the pipeline.

The pair of complementary sensor elements may be operable to detect relative displacement of the platforms and thereby provide an indication of pressure variation within the pipeline.

Each supporting bracket is preferably formed from a material having a low coefficient of thermal expansion. This ensures that the relative displacement is primarily related to variations in pipeline pressure rather than to variations in bracket dimensions due to thermal expansion. Suitable materials include alloys such as invar or the like. Each supporting bracket is preferably formed from the same or a similar material. This ensures that the supporting brackets are thermally matched, i.e. they expand to the same degree due to changes in ambient temperature. For the same reason, the supporting brackets may be formed from the same or a similar material to the pipeline.

Each supporting brackets may be mounted around the surface of the pipeline by means of a dedicated brace. In a preferred embodiment, each supporting bracket is mounted around the pipe by means of a common brace. A common brace may be provided with means for correctly locating the respective supporting brackets. The brace may comprise one or more bands strapped around the circumference of the pipeline. Preferably two bands are used. Preferably the bands are formed from steel. The brace may be engageable with one or more feet provided on a supporting bracket. The brace can help facilitate correct installation of the device on a pipeline.

In one embodiment, the or each brace may take the form or one or more circumferential ribs operable to clamp each supporting bracket to the pipeline at the desired positions. In some embodiments, each supporting bracket may be mounted to the outer surface of the pipeline at two points. This can increase the stability of the supporting bracket.

When each supporting bracket is mounted to a separate point, the axial displacement between the mounting points of the supporting brackets is preferably much smaller than the radial displacement between the mounting points of the support brackets. In a preferred embodiment, the axial displacement is preferably less than the radius of the pipeline and is most preferably significantly less than the radius of the pipeline. The radial displacement between the mounting points of the supporting brackets is preferably a significant fraction of the pipeline circumference. The radial displacement between the mounting points may be between 2 degrees and 180 degrees. In one preferred embodiment the displacement between the mounting points of the supporting brackets is of the order of 90 degrees. In another preferred embodiment, the displacement between the mounting points of the supporting brackets is of the order of 180 degrees.

Each supporting bracket may comprise one or more arms. Preferably, each supporting bracket comprises two arms. A supporting bracket may comprise a short arm or body extending radially from its mounting point. A supporting bracket may comprise one or more curved arms extending away from its mounting point and around the exterior of the pipeline. A supporting bracket's arms can help to mount the supporting bracket to the pipeline.

Each supporting bracket may comprise one or more feet. Preferably the one or more feet are arranged so that they align substantially parallel to the pipeline when the supporting bracket is mounted to the pipeline. The one or more feet may be engageable with a brace or steel band. The feet can help to mount the supporting bracket to the pipeline.

Each supporting brackets may preferably be formed so as to support its respective platform at substantially adjacent positions within the sensing range of the sensor elements. Preferably, each supporting brackets is adapted to support its respective platform at a position radially displaced from the exterior surface of the pipeline. Preferably, the radial displacement of a platform from the exterior surface of the pipeline is less than the expected relative displacement of the platform due to changes in shape or size of the pipe. Most preferably, the radial displacement of a platform from the exterior surface of the pipeline is at least an order of magnitude greater than the expected relative displacement of the platform due to changes in shape or size of the pipe. This ensures that measurement of relative displacement of a platform is not limited by the expected range of variation in the shape or size of the pipeline.

Each reference platform may comprise a base upon which a sensor element may be provided. In preferred embodiments, the or each reference platform additionally comprises a protective housing for its sensor element. The protective housing of the respective platforms may partially overlap. This can provide further protection for the sensor elements.

At least one of the sensor elements may be housed in a sensor assembly. Both sensor elements may be housed in a sensor assembly. Alternatively, one of the sensor elements may be exposed to the outside environment.

One of the sensor elements may comprise a target element. The target element may be detectable by the sensor element. The target element may be attached directly to the external surface of the pipeline by use of a suitable means such as an adhesive.

The pressure sensing device preferably comprises a cover for housing the device. The cover may be arranged to protect the device from ingress of solid particles or liquid. Thus the cover may seal the device from the outside environment. The cover may therefore offer ingress protection, which is particularly important when the device is mounted to a pipeline buried underground or located in water.

The complementary pair of sensor elements may comprise a proximity sensor. In particular, the sensor elements may comprise any suitable form of proximity sensor including but not limited to: optical, infrared, ultraviolet, capacitive, eddy current, magnetic, ultrasonic or the like.

In one embodiment, one sensor element may comprise one or more light emitting means and the other sensor element may comprise one or more light receiving means. In such embodiments, the light emitting means are preferably light emitting diodes (LEDs), nevertheless other light emitting means may be utilised in alternative implementations if desired. In such embodiments, the light receiving means preferably comprise a photodetector or an array of photodetectors. In preferred embodiments, the light emitting means may emit visible light and the light receiving means may detect visible light. In alternative implementations, the light emitting and receiving means may operate using infrared or ultraviolet light.

In another embodiment, one sensor element may comprise a magnet and the other sensor element may comprise a magnetic field sensor. In such embodiments, the magnet is preferably a permanent magnet. In such embodiments, the magnetic field sensor is preferably a Hall effect sensor.

In a further embodiment, one sensor element may comprise a capacitive proximity sensor and the second sensor element may comprise a probe detectable by the capacitive proximity sensor.

In a still further embodiment, one sensor element may comprise an eddy current proximity sensor and the second sensor element may comprise a probe or target detectable by the eddy current proximity sensor. The probe or target may be formed from a ferrous material. In alternative embodiments, the probe or target may be formed from a non-ferrous material.

The pressure sensing device preferably comprises a processing unit operable to process signals output by at least one of the sensor elements so as to determine the relative displacement of said sensor elements. The processing unit may also determine the relative displacement of the reference platforms. The processing unit may additionally be operable to process said signals to provide an indication of a pressure variation within the pipeline or an absolute pressure within the pipeline.

The pressure sensing device may be provided with a communication unit operable to communicate indications of the relative displacement of the sensor elements, the reference platforms, pressure variation within the pipeline and/or an absolute pressure within the pipeline to one or more external devices. The communication unit may additionally be operable to receive information and/or instructions from external devices. Preferably, the communication unit is operable to transmit and receive information using a suitable wireless data network. Nevertheless, where a wired data link is provided, the communication unit may be operable to transmit and receive information using a suitable wired data network.

According to a second aspect of the invention there is provided a pressure sensing device operable to monitor pressure variations within a fluid pipeline, the sensing device comprising: a pair of complementary sensor elements, each element provided upon a separate reference platform, wherein each reference platform is provided upon a supporting bracket, and wherein each supporting bracket is mounted to a separate point on the external surface of the pipeline such the pair of reference platforms experience relative displacement as the external surface of the pipeline undergoes changes in size or shape; and wherein the complementary sensor elements provided on said platforms are operable to detect said relative displacement of the platforms and thereby provide an indication of pressure variation within the pipeline.

By mounting the supporting bracket at different points around the circumference of the pipeline, the relative displacement of the platforms is related to variations in the external size and shape of the pipeline, which are in turn determined by variation in pressure within the pipeline. Accordingly the present invention provides for convenient measurement of internal pressure within a pipeline using an externally mounted device. As the device is externally mounted, it can be readily fitted, serviced or repositioned without impacting on the flow within the pipeline.

The device of the second aspect of the present invention may incorporate any or all features of the device of the first aspect of the invention as desired or as appropriate. According to a third aspect of the present invention there is provided a method of monitoring a pipeline comprising the steps of: fitting one or more sensing devices according to the first or second aspects of the present invention to a pipeline; and monitoring the output of the or each said sensing device.

The method of the third aspect of the present invention may incorporate any or all features of the device of the first or second aspects of the invention as desired or as appropriate.

According to a fourth aspect of the present invention there is provided a pipeline for transporting fluid, the pipeline fitted with one or more pressure sensing devices according to the first or second aspects of the present invention.

The pipeline of the fourth aspect of the present invention may incorporate any or all features of the first, second or third aspects of the present invention, as desired or as appropriate.

### DETAILED DESCRIPTION OF THE INVENTION

In order that the invention may be more clearly understood embodiments thereof will now be described, by way of example only, with reference to the accompanying drawings, of which:

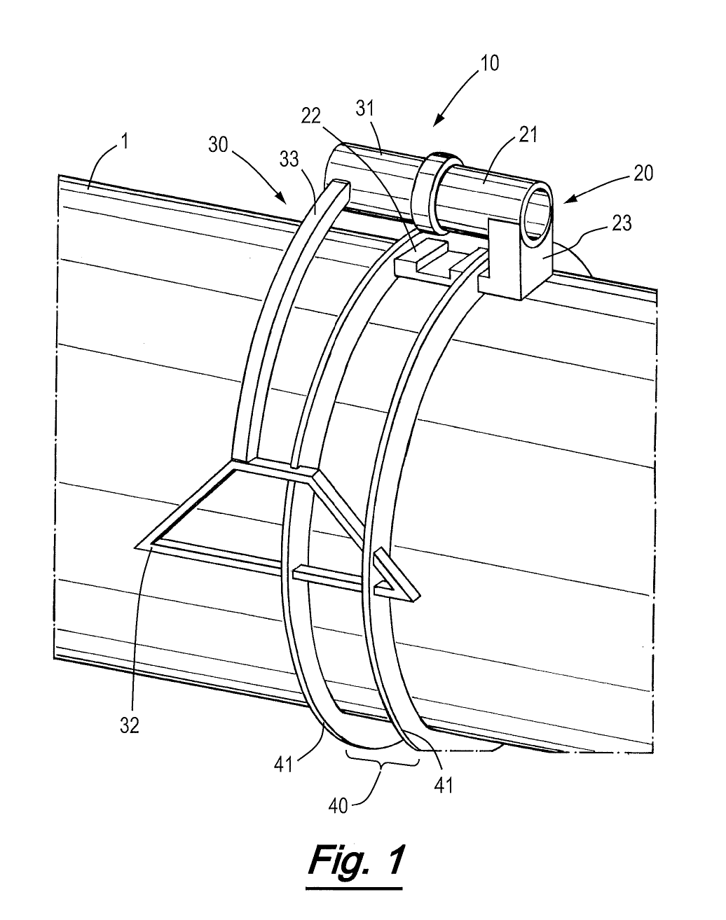

FIG. 1 illustrates a first embodiment of an external pressure sensing device for a fluid pipeline according to the present invention;

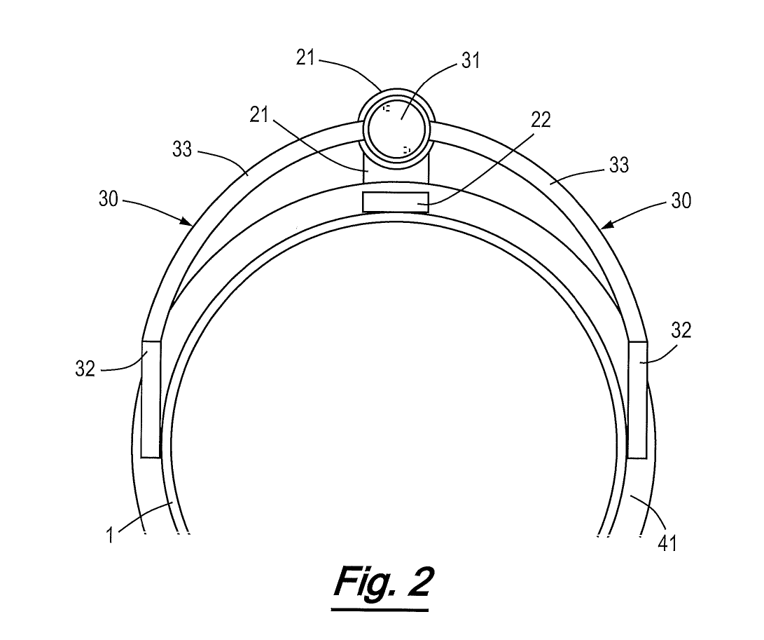

FIG. 2 is a side view of the device of FIG. 1;

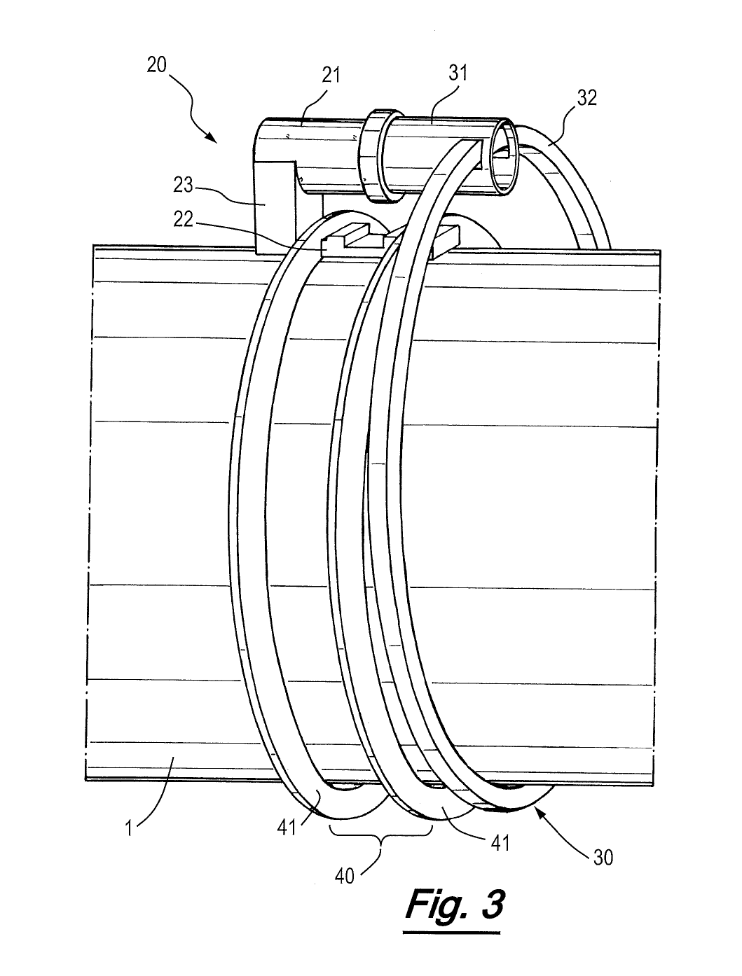

FIG. 3 illustrates a second embodiment of an external pressure sensing device for a fluid pipeline according to the present invention;

FIG. 4 is a cross-sectional view of the pipeline and device of FIG. 3;

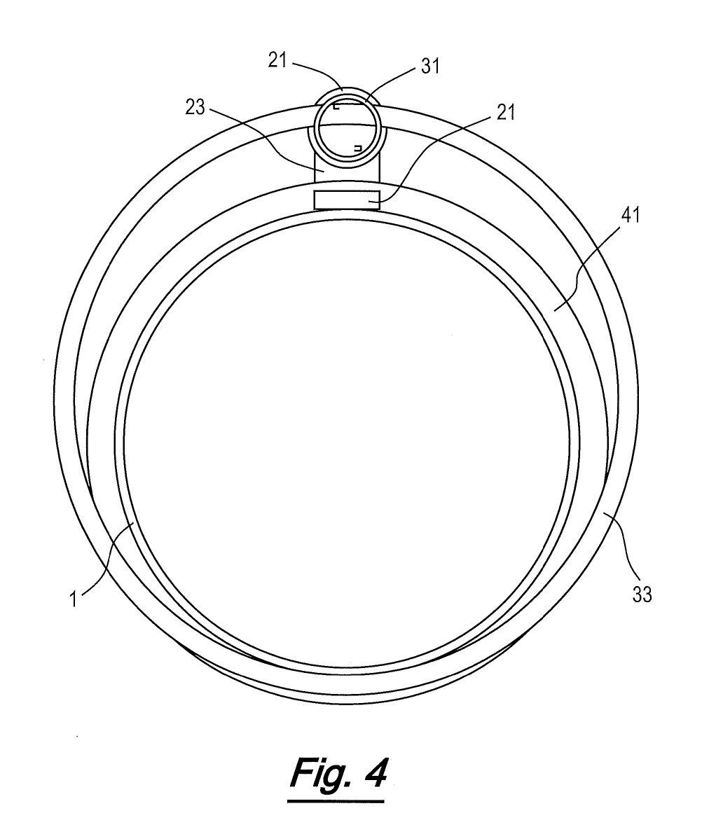

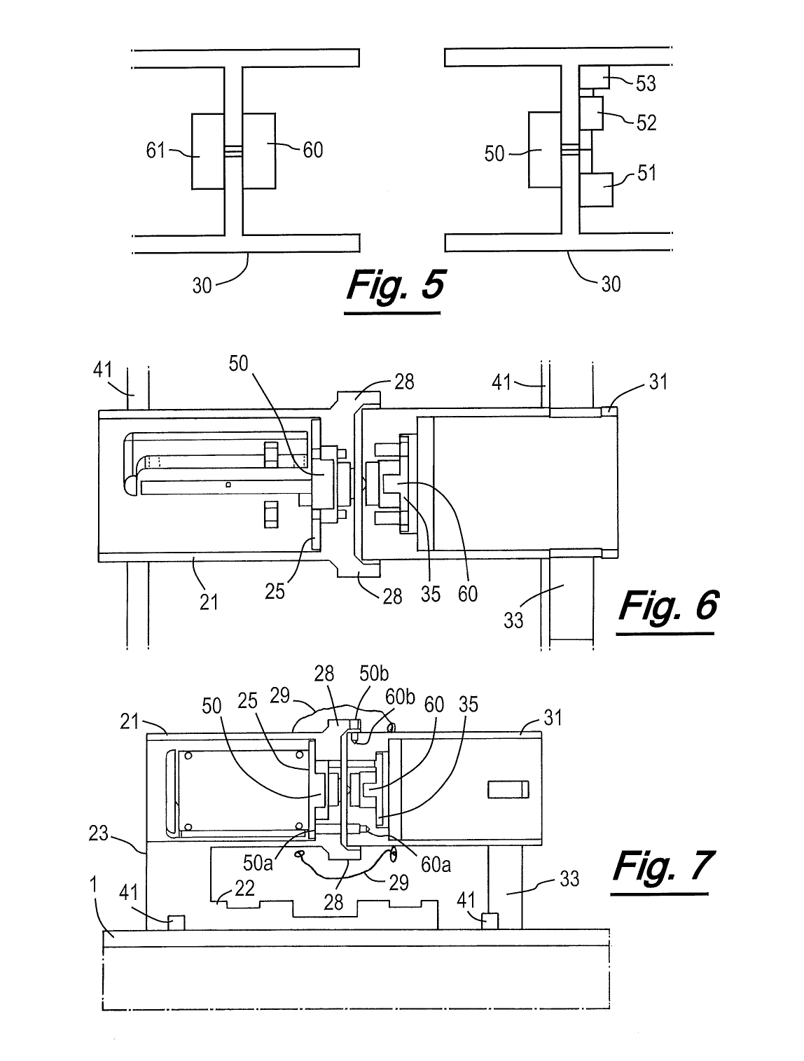

FIG. 5 is a schematic block diagram of the sensor elements and associated components provided for a pressure sensor according to the present invention;

FIG. 6 is a schematic horizontal cross-sectional illustration of an optical sensor element arrangement for a pressure sensor according to the present invention;

FIG. 7 is a schematic vertical cross-sectional illustration of an optical sensor element arrangement for a pressure sensor according to the present invention;

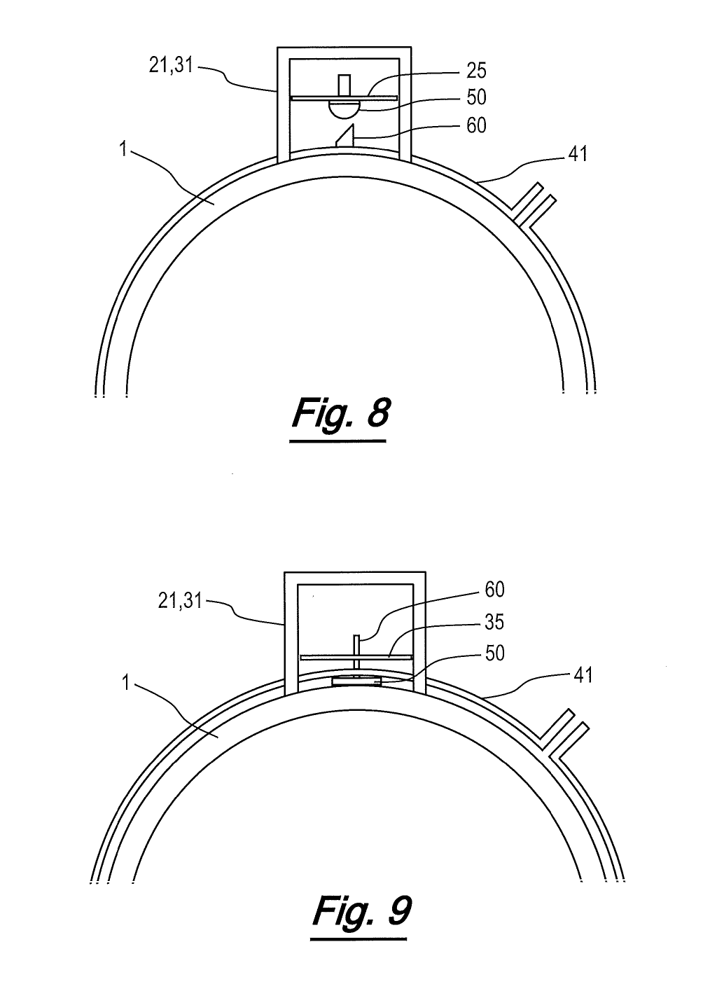

FIG. 8 is a schematic illustration of an magnetic sensor element arrangement for a pressure sensor according to the present invention;

FIG. 9 is a schematic illustration of a capacitive sensor element arrangement for a pressure sensor according to the present invention.

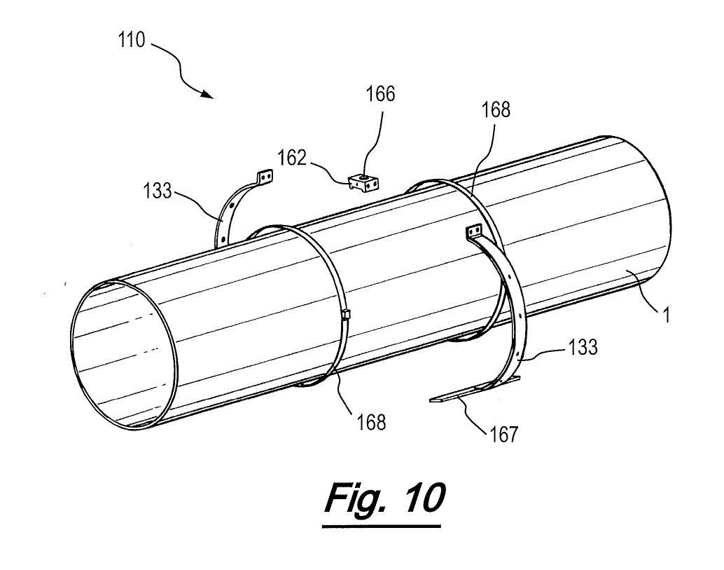

FIG. 10 illustrates a perspective view of a third embodiment of an external pressure sensing device for a fluid pipeline according to the present invention, with the sensor element removed and the device separated from the pipeline;

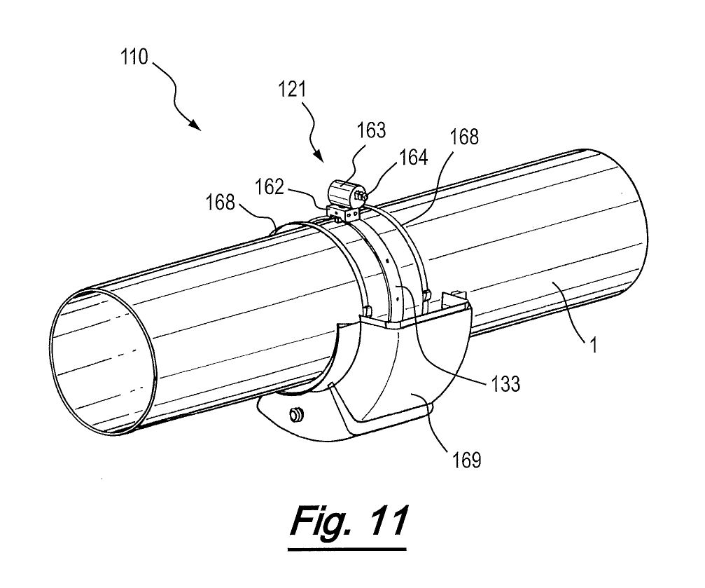

FIG. 11 illustrates a perspective view of the device of FIG. 10, with the device mounted to the pipeline and a cover partially fitted to the device; and

FIG. 11 is a side view of the device of FIGS. 10 and 11, with the device mounted to the pipeline and the cover removed from the device.

Turning now to FIGS. 1 & 2, an externally mounted pressure sensing device 10 for a pipeline 1 comprises a first support bracket 20, and a second support bracket 30, mounted to different points around the exterior of the pipeline 1. At the distal end of each supporting bracket 20, 30 is provided a protective housing 21, 31 within each housing 21, 31 is a reference platform 25, 35. Upon the respective reference platforms 25, 35 are mounted complementary sensor elements 50, 60.

As each supporting bracket 20, 30 is mounted to a separate point on the external surface of the pipeline 1, the pair of reference platforms 25, 35 experience relative displacement as the exterior of the pipeline 1 undergoes changes in size or shape due to pressure variation within the pipeline 1. The complementary sensor elements 50, 60 together comprise a proximity sensor and are operable to measure the relative displacement of the platforms 25, 35 and thereby provide an indication of pressure variation within the pipeline 1. The sensor elements 50, 60 may comprise any suitable form of proximity sensor including but not limited to: optical, capacitive, eddy current, magnetic, ultrasonic or the like. Particular examples of suitable proximity sensor arrangements will be discussed in more detail below, by way of example only.

The supporting brackets 20, 30 are held in position by means of a common brace 40 comprising a pair of circumferential ribs 41. The ribs 41 act to clamp the supporting brackets 20, 30 to the pipeline 1 at the desired mounting points. Accordingly, each supporting bracket 20, 30 moves with changes in size or shape of the pipeline 1 at the respective mounting points. In order to minimise the influence of temperature variation on pressure measurements, the supporting brackets 20, 30 may be formed from a material with a low coefficient of thermal expansion, such as the alloy invar or the like, and they may be formed from the same or a similar material as the pipe wall to ensure they are thermally matched.

The first support bracket 20 comprises a short arm 23 extending radially from the said mounting point on the pipeline 1 and a base 22 adapted to be clamped by the brace 40. The second supporting bracket 30 comprises a base 32 adapted to be clamped by the brace 40 and a curved arm 33 extending away from the said mounting point and around the exterior of the pipeline 1. For greater stability, as is shown most clearly in FIG. 2, the second supporting bracket 30 comprises a pair of bases 32 adapted to be clamped by the brace 40 at opposing sides of the pipeline 1 and a pair of curved arms 33 extending away from the said mounting point and around the exterior of the pipeline 1. Whilst the base 32 is shown to be of trapezoidal form in FIGS. 1-3, alternative forms may be used if desired or appropriate.

Turning now to FIGS. 3 & 4, these depict a device 10 utilising an alternative arrangement of the second supporting bracket 30. In FIGS. 4 and 5, the second supporting bracket 30 comprises a single curved arm 33 mounted directly to the pipeline 1 at a point substantially opposite the first supporting bracket. The curved arm 33 extends away from the said mounting point in both directions and around the exterior of the pipeline 1 so as to position the housing 31 and associated reference platform 35 adjacent to the housing 21 and platform 25.

The embodiment of FIGS. 4 & 5 has the benefit of maximising the separation between the mounting points of the first and second supporting brackets 20, 30. This increases the range of relative displacement between the reference platforms in response to changes in shape or size of the pipeline 1. Nevertheless, the increase in rage comes at a cost of lesser security in attachment and greater susceptibility to vibration induced errors.

Turning now to the housings 21, 31, in FIGS. 1-5, the housing 21 is shown to slightly overlap the housing 31. This can provide some protection from the local environment for the sensor elements. Typically, the housings 21, 31 may be adapted to house additional components of the device 10 such as a power source 51, 61, processing unit 52 or communication unit 53 as is illustrated schematically in FIG. 5. The skilled man will of course appreciate that in embodiments wherein only one of the sensor elements 50, 60 needs to be powered, the second power source 61 can be omitted.

In normal operation, the processing unit 52 is operable to receive signals output by at least sensor element 50, to determine the relative displacement of said sensor elements 50, 60 and hence the relative displacement of said reference platforms 21, 31. The processing unit 52 may additionally be operable to process said signals to provide an indication of a pressure variation within the pipeline 1 or an absolute pressure within the pipeline 1.

The device 10 may also be provided with communication unit 53 operable to communicate with one or more external devices (not shown). Typically, this communication might take place via a suitable wireless datalink, but in appropriate circumstances a hard wired link may be used in addition or as an alternative. Typically, the communication unit 53 will communicate indications of the relative displacement of said reference platforms, pressure variation within the pipeline or absolute pressure within the pipeline to one or more external devices. The communication unit 53 may additionally be operable to receive information and/or instructions from external devices. In some embodiments, the device 10 may additionally be provided with a data storage means. This can allow output data from the sensing elements 50, 60 to be stored within the device 10 and communicated to external devices in batches at prearranged intervals or in response to specific requests. In some such embodiments, the processing unit may be operable to initiate communication of sensor data in response to absolute pressure or pressure variation within the pipeline falling outside threshold limits.

Turning now to the specific example of FIGS. 6 & 7, these illustrate an embodiment of the device utilising optical sensor elements 50, 60. A light emitting element 60 (for instance an LED) is provided upon platform 35 within housing 30. Light from the light emitting element 60 is collimated by passing through aperture 39. The collimated light is then incident upon light sensing array 50 mounted on platform 25, as the relative displacement of the light emitting element 60 varies with respect to the light sensing array, the position within the array upon which the collimated light is incident varies. By monitoring this point of incidence, the relative displacement of the sensor elements 50, 60 can be determined and hence variations in pipeline 1 pressure can be determined.

As is shown in FIGS. 6 & 7, such an embodiment may optionally also include a rim 28 on the first housing which at least partially overlaps the end of the second housing 30. This can restrict ambient light from falling on the sensing array 50. It is of course possible in alternative embodiments that the rim may be provided on the second housing. It is still further possible to supplement rim 28 with a further enclosure 29. Such a further enclosure 29 may comprise a ring or flexible sheet.

In order to help confirm calibration of the device 10 or that the sensors 50, 60 remain within range, it is possible to provide additional light emitting elements 60a, 60b positioned within apertures 39a and 39b and corresponding light sensors 50a, 50 b. in the event that light sensors 50a, 50b fail to detect the light emitted by light emitting elements 60a, 60b, or the light level detected drops below a pre-set threshold, it may be determined that the relative displacement between sensor elements 50, 60 has exceeded a normal range. This may indicate that the device 10 requires recalibration or may be indicative of a significant danger of a leak or other pipeline emergency.

Turning now to FIG. 8, there is shown schematically an alternative to the optical sensor embodiment discussed above. In this embodiment, the first supporting bracket may carry a capacitive proximity sensor 50 on the reference platform 25 and the second supporting bracket may carry a conductive probe 60 on the platform 35. Once again, as the relative displacement between the capacitive sensor 50 and probe 60 varies, so does the output of the capacitive sensor 50. This allows the relative displacement to be determined and hence variations in pipeline 1 pressure can be determined.

Turning now to FIG. 9, there is shown schematically another alternative to the optical sensor embodiment discussed above. In this embodiment, the first supporting bracket may carry a Hall effect probe 50 on the reference platform 25 and the second supporting bracket may carry a magnet 60 on the platform 35. Once again, as the relative displacement between the Hall effect probe 50 and magnet 60 varies, so does the output of the Hall effect probe 50. This allows the relative displacement to be determined and hence variations in pipeline 1 pressure can be determined.

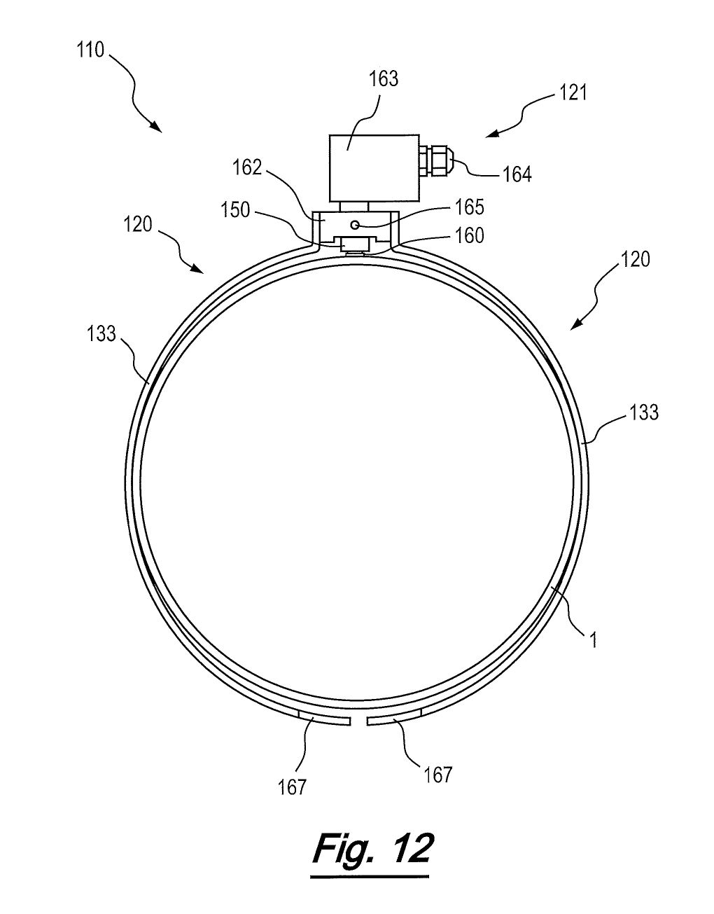

Turning now to FIGS. 10, 11 and 12, an externally mounted pressure sensing device 110 for a pipeline 1 comprises a supporting bracket 120 mounted around the exterior of the pipeline 1. The supporting bracket 120 comprises a pair of curved arms 133 that are attached at a proximal end to a sensor assembly 121. Each supporting bracket 210 is also attached at a distal end to a foot 167. The device 110 is secured to the pipeline 1 by engaging the feet 167 with a pair of circumferential steel bands 168 that are fixed around the exterior of the pipeline 1. The feet 167 fit under the steel bands 168, which are tightened circumferentially to fix the feet 167 and thus the device 110 in its position relative to the pipeline 1.

The sensor assembly 121 comprises a bracket 162 that has a vertically oriented mounting hole 166 through which a sensor element 150 can be inserted. A ferrous target element 160 is bonded to a top part of the pipe 1 using an adhesive, adjacent and in line with the sensor element 150. Thus, in this embodiment the pair of complementary sensor elements comprises a sensor element 150 and a target element 160. When the device 110 is mounted to the pipeline 1, the bracket 162 is fixed relative to the target element 160. The position of the sensor element 150 is moveable relative to the bracket 162 by loosening and tightening a grub screw 165 that is engageable with a part of the sensor element 150. In this embodiment, the sensor element 150 comprises an eddy current sensor.

The sensor assembly 121 further comprises a housing 163 and a cable gland 164 of sufficient ingress protection.

The height of the sensor element 150 relative to the target element 160 can be adjusted by use of the grub screw 165 so that the sensor element 150 can positioned in an optimal sensing position relative to the target element 160, which is around 0.5 mm above the surface of the target element 160.

As is shown in FIG. 11, the supporting bracket 120, the sensor assembly 121 and the steel bands 168 may be encased in a cover 169 to improve their ingress protection against liquids and solid particles. Indeed, by using the cover 169, some embodiments of the invention are able to obtain a high level of ingress protection, such as an IP68 rating. The cover 169 is particularly important when the device 110 is mounted to an underground pipeline 1.

In use, a plurality of devices 110 is installed at separate, known positions along the pipeline 1. Thus, each sensor element 150 experiences a different displacement relative to its target element 160 as the exterior of the pipeline 1 undergoes changes in size or shape due to pressure variation within the pipeline 1. The complementary sensor element 150 and target element 160 are together operable to measure this displacement and thereby provide an indication of pressure variation within the pipeline 1, along pipeline 1.

The above embodiments are described by way of example only. Many variations are possible without departing from the scope of the invention as defined in the appended claims.

1. A pressure sensing device operable to monitor pressure variations within a fluid pipeline, the pressure sensing device comprising: a pair of complementary sensor elements, at least one of the sensor elements mounted to a supporting bracket that is mounted to a point on the external surface of the pipeline, wherein the at least one sensor element is mounted such that the pair of complementary sensor elements experience relative displacement as the external surface of the pipeline undergoes changes in size or shape;
and wherein the pair of complementary sensor elements are operable to detect said relative displacement and thereby provide an indication of pressure variation within the pipeline.

2. A pressure sensing device as claimed in claim 1 wherein each sensor element is mounted to a supporting bracket.

3. A pressure sensing device as claimed in claim 2 wherein at least one of the sensor elements is provided on a reference platform mounted to a supporting bracket.

4. (canceled)

5. A pressure sensing device as claimed in claim 3 wherein each supporting bracket is mounted to a separate point on the external surface of the pipeline.

6. (canceled)

7. (canceled)

8. A pressure sensing device as claimed in claim 1 wherein each supporting bracket is mounted to a point around the surface of the pipeline by means of a brace, said brace provided around the circumference of the pipeline.

9-13. (canceled)

14. A pressure sensing device as claimed in claim 1 wherein each supporting bracket comprises one or more arms.

15. (canceled)

16. (canceled)

17. A pressure sensing device as claimed in claim 1 wherein each supporting bracket comprises one or more feet.

18. (canceled)

19. A pressure sensing device as claimed in claim 3 wherein the supporting brackets support the respective platforms at substantially adjacent positions within the sensing range of the sensor elements.

20. A pressure sensing device as claimed in claim 3 wherein the supporting brackets are adapted to support the respective platforms at a position radially displaced from the exterior surface of the pipeline.

21. (canceled)

22. (canceled)

23. A pressure sensing device as claimed in claim 3 wherein the reference platform additionally comprises a protective housing for the sensor elements.

24-27. (canceled)

28. A pressure sensing device as claimed in claim 1 further comprising a cover for housing the pressure sensing device.

29. (canceled)

30. A pressure sensing device as claimed in claim 1 wherein the pair of complementary sensors elements comprise a proximity sensor.

31. A pressure sensing device as claimed in claim 1 wherein one sensor element comprises one or more light emitting means and the other sensor element comprises one or more light receiving means.

32. (canceled)

33. (canceled)

34. A pressure sensing device as claimed in claim 1 wherein one sensor element comprises a magnet and the other sensor element comprises a magnetic field sensor.

35. (canceled)

36. A pressure sensing device as claimed in claim 1 wherein one sensor element comprises a capacitive proximity sensor and the second sensor element comprises a probe detectable by the capacitive proximity sensor.

37. A pressure sensing device as claimed in claim 1 wherein one sensor element comprises an eddy current proximity sensor and the second sensor element comprises a probe or target detectable by the eddy current proximity sensor.

38. A pressure sensing device as claimed in claim 1 wherein the device comprises a processing unit operable to process signals output by at least one of the sensor elements so as to determine the relative displacement of said sensor elements, pressure variation within the pipeline or an absolute pressure within the pipeline to one or more external devices.

39. (canceled)

40. A pressure sensing device as claimed in claim 1 wherein the device is provided with a communication unit operable to communicate indications of the relative displacement of the sensor elements, the reference platforms, pressure variation within the pipeline or an absolute pressure within the pipeline to one or more external devices.

41. (canceled)

42. (canceled)

43. A method of monitoring a pipeline comprising the steps of: fitting one or more pressure sensing devices to a pipeline, said pressure sensing device operable to monitor pressure variations within a fluid pipeline, the pressure sensing device comprising: a pair of complementary sensor elements, at least one of the sensor elements mounted to a supporting bracket that is mounted to a point on the external surface of the pipeline, wherein the at least one sensor element is mounted such that the pair of complementary sensor elements experience relative displacement as the external surface of the pipeline undergoes changes in size or shape; and wherein the pair of complementary sensor elements are operable to detect said relative displacement and thereby provide an indication of pressure variation within the pipeline; and monitoring the output of each said pressure sensing device.

44. A pipeline for transporting fluid, the pipeline fitted with one or more pressure sensing devices operable to monitor pressure variations within a fluid pipeline, the pressure sensing device comprising: a pair of complementary sensor elements, at least one of the sensor elements mounted to a supporting bracket that is mounted to a point on the external surface of the pipeline, wherein the at least one sensor element is mounted such that the pair of complementary sensor elements experience relative displacement as the external surface of the pipeline undergoes changes in size or shape; and wherein the pair of complementary sensor elements are operable to detect said relative displacement and thereby provide an indication of pressure variation within the pipeline.
